(19) United States
(12) Patent Application Publication
(10) Pub. No.: US 2021/0173863 A1
(43) Pub. Date: Jun. 10, 2021

(54) FRAMEWORKS AND METHODOLOGIES CONFIGURED TO ENABLE SUPPORT AND DELIVERY OF A MULTIMEDIA MESSAGING INTERFACE, INCLUDING AUTOMATED CONTENT GENERATION AND CLASSIFICATION, CONTENT SEARCH AND PRIORITISATION, AND DATA ANALYTICS

(71) Applicant: Prockopee Holdings Pte Ltd

(72) Inventor: Daniel Patrick COLLINS, Sydney, New South Wales (AU)

(21) Appl. No.: 16/334,580

(22) PCT Filed: Sep. 19, 2017
(86) PCT No.: PCT/IB2017/055644

§ 371 Date: Mar. 19, 2019

(30) Foreign Application Priority Data
Sep. 19, 2016 (AU) 2016903755
Sep. 19, 2016 (AU) 2016903757
Sep. 19, 2016 (AU) 2016903759
Sep. 19, 2016 (AU) 2016903761
Sep. 19, 2016 (AU) 2016903762
Sep. 19, 2016 (AU) 2016903768
Sep. 19, 2016 (AU) 2016903984

(51) Int. Cl. G06F 16/435; G06F 16/41; G06F 16/48; G06F 16/438

(52) U.S. Cl. CPC G06F 16/435; G06F 16/438; G06F 16/489; G06F 16/41

(57) ABSTRACT

The present invention relates to frameworks and methodologies configured to enable support and delivery of a multimedia messaging interface, including (but not limited to) automated content generation and classification, content search and prioritisation, and data analytics. Some embodiments relate to frameworks and methodologies configured to enable generation of and management of content items, which are optionally made available via a messaging interface, via media artefact identification (for example based on contextual data, audio, text and/or object recognition). Examples include technology that enables automated generation and categorisation of sub-clips from one or more media source files. Other embodiments relate to content promotion functionalities for a content library driven video/animation messaging framework, multi-dimensional search and display of animated content made available via a messaging interface, including filtered delivery of clip segments to a messaging interface based on conversation genre determination, and content ordering based on utilisation and non-utilisation analytics in a content library driven video/animation messaging framework.

### FIELD OF THE INVENTION

The present invention relates to frameworks and methodologies configured to enable support and delivery of a multimedia messaging interface, including (but not limited to) automated content generation and classification, content search and prioritisation, and data analytics. Some embodiments relate to frameworks and methodologies configured to enable generation of and management of content items, which are optionally made available via a messaging interface, via media artefact identification (for example based on contextual data, audio, text and/or object recognition). Examples include technology that enables automated generation and categorisation of sub-clips from one or more media source files. For example, such embodiments address technical problems associated with efficient population of content libraries from source content. Some embodiments relate to frameworks and methodologies configured to enable content promotion functionalities for a content library driven video/animation messaging framework. For example, these address technical problems associated with efficiently managing access to a large amount of content. Some embodiments relate to frameworks and methodologies configured to enable multi-dimensional search and display of animated content made available via a messaging interface, including filtered delivery of clip segments to a messaging interface based on conversation genre determination. For example, these address technical problems associated with efficiencies in content searches. Some embodiments relate to frameworks and methodologies configured to enable content ordering based on utilisation and non-utilisation analytics in a content library driven video/animation messaging framework. For example, these address technical problems associated with dynamically understating content relevance, thereby to optimise search and retrieval functionalities.

### BACKGROUND

Any discussion of the background art throughout the specification should in no way be considered as an admission that such art is widely known or forms part of common general knowledge in the field.

Instant messaging software has become perhaps the most prevalent communication mediums in modern society. A variety of platforms are widely used, including SMS/MMS, iMessage, Facebook Messenger, Whatsapp, and others. As the popularity of instant messaging has increased, the nature of its usage has evolved. What began with plain text evolved to accommodate media (in particular photos and videos), emoji (and other icons), and the like.

More recently, instant messaging platforms have begun to interact with various content libraries, thereby to provide content that is available for incorporation into messaging. For example, Giphy provide a searchable content library that allows instant messaging users to identify and share GIF files, often as a means of expressing thoughts and/or emotions in an entertaining and non-textual manner.

A first category of technical problems arises in the context of generating content libraries, with adequate metadata to enable searching. For example, this may include efficiently (and preferably autonomously) processing substantial amounts of media data (for example video data) thereby to identify individual clips that are of potential utility for a secondary purpose, for example a messaging interface.

A second category of technical problems arises in the context of search and retrieval functionalities for a substantial content library. For example, in the context of messaging applications, there are particular technical imperatives to optimise delivery of the most relevant results, for example due to a small screen area available to deliver search results, and high velocity user interaction with a messaging interface.

### SUMMARY OF THE INVENTION

It is an object of the present invention to overcome or ameliorate at least one of the disadvantages of the prior art, or to provide a useful alternative. Various claims define technical solutions to technical problems in their respective fields of application.

One embodiment provides a computer implemented method for generating a clip content library, the method including:
receiving data representative of a media source, wherein the media source is defined by a plurality of ordered image frames, including frames F₀ corresponding to a reference time T₀ and a frame Fₙ corresponding to a reference time Tₙ, wherein reference times T₀ and Tₙ are defined on a timeline;
identifying media timeline contextual data associated with the media source, the media timeline contextual data including data correlated to a time period corresponding to the time period including T₀ to Tₙ;
processing the media timeline contextual data based on one or more segmentation algorithms, thereby to define a plurality of clip segments, wherein each clip segment includes:
(i) clip segment contextual data derived from the media timeline contextual data; and
(ii) data representative of a clip segment time period defined relative to the timeline, wherein for a given clip segment the clip segment time period is from Tᵢ to Tⱼ, wherein 0≤i≤j≤n;
storing data representative of the defined clip segments in a clip content library.

One embodiment provides a method including configuring the clip content library to make the data representative of the defined clip segments available for access via a messaging interface, such that the messaging interface is enabled to:
(i) perform a search thereby to identify a search result set including one or more clip segments, wherein the search is based upon a search query that is processed against clip segment contextual data;
(ii) enable the user to review the result set and then select a desired clip segment from the search result set; and
(iii) cause rendering at a recipient device of a set of frames from the media source associated with the clip segment time period.

One embodiment provides a method wherein causing rendering at a recipient device of a set of frames from the media source associated with the clip segment time period includes: delivering to the recipient device frame data for the set of frames.

One embodiment provides a method wherein the frame data is available in the clip content library.

One embodiment provides a method wherein the frame data is available from a master media source.

One embodiment provides a method wherein causing rendering at a recipient device of a set of frames from the media source associated with the clip segment time period includes: delivering to the recipient device data that causes retrieval of frame data for the set of frames.

One embodiment provides a method wherein the frame data is retrieved from the clip content library.

One embodiment provides a method wherein the frame data is retrieved from a data source other than the clip content library.

One embodiment provides a method wherein the frame data for the set of frames is stored as an isolated frame data set.

One embodiment provides a method wherein the frame data for the set of frames is retrieved via on-demand extraction from a larger media file using the data representative of the clip segment time period.

One embodiment provides a method wherein the media timeline contextual data associated with the media source includes subtitle data.

One embodiment provides a method including applying a processing algorithm thereby to extract searchable text data from the subtitle data.

One embodiment provides a method wherein the processing algorithm includes a character recognition algorithm.

One embodiment provides a method wherein the media timeline contextual data associated with the media source includes a contextual log.

One embodiment provides a method wherein the contextual log is manually defined.

One embodiment provides a method wherein the one or more segmentation algorithms include one or more segmentation algorithms configured to identify sentence and/or conversation delimiters.

One embodiment provides a method wherein the one or more segmentation algorithms include one or more segmentation algorithms configured to identify logically separable segments of less than a threshold time period.

One embodiment provides a method wherein the one or more segmentation algorithms additionally process the media frame data, thereby to identify media-based clip delimiters.

One embodiment provides a device that is configured to execute a messaging interface that delivers a result set of clip segments in response to a search query, wherein clip segments are identified in a clip content library generated according to a method as described above.

One embodiment provides a computer implemented method for enabling searching of clip segments stored in a content library, the method including:
maintaining access to a content library including a plurality of clip segments, wherein each clip segment includes:
(i) clip segment contextual data, the clip segment contextual data being representative of one or more media events experienced when the clip segment is rendered; and
(ii) clip segment attribute data, the clip segment attribute data being representative of non-event attributes of the clip segment;
receiving a search query, wherein the search query is derived from input at a client device;
processing the search query against the clip segment contextual data based on a first set of predefined search logic; and
applying one or more filters in respect of a result set generated via the processing of the search query against the clip segment contextual data based on a first set of predefined search logic, wherein the filters are applied based on clip segment attribute data.

One embodiment provides a method wherein the clip segment contextual data includes text-based data representative of media timeline speech, such that processing the search query against the clip segment contextual data based on a first set of predefined search logic identifies one or more clip segments having speech corresponding to the search query.

One embodiment provides a method including applying a natural language processing algorithm thereby to enable identification of natural language variations between the search query and the media timeline speech.

One embodiment provides a method wherein two or more of the clip segments are defined from a single master clip based on operation of a speech-responsive segmentation algorithm.

One embodiment provides a method including: additionally processing the search query against the clip segment contextual data based on a second set of predefined search logic; and causing a user interface to enable shifting between a first result set based on the first set of predefined search logic and a second result set based on the second set of predefined search logic.

One embodiment provides a method wherein the user interface is configured to enable navigation of each result set along a first axial dimension, and navigation between the result sets along a second axial dimension.

One embodiment provides a method wherein navigation along the first axial dimension is continuous, and navigation along the second axial dimension is stepwise between result sets.

One embodiment provides a method including: applying a first set of filter conditions thereby to define a first result set; applying a second set of filter conditions thereby to define a second result set; and configuring a user interface to enable switching between the first result set and second result set.

One embodiment provides a method wherein the user interface is configured to enable navigation of each result set along a first axial dimension, and navigation between the result sets along a second axial dimension.

One embodiment provides a method wherein navigation along the first axial dimension is continuous, and navigation along the second axial dimension is stepwise between result sets.

One embodiment provides a method wherein the first set of predefined search logic is responsive to a content promotion algorithm.

A computer implemented method for enabling searching of clip segments stored in a content library, the method including:
maintaining access to a content library including a plurality of clip segments, wherein for each clip segment the content library maintains searchable text-based data representative of media timeline speech for the clip segment;
receiving a search query, wherein the search query is derived from input at a client device;
processing the search query against the searchable text-based data representative of media timeline speech, thereby to determine a result set of clip segments; and
causing a user interface object at the client device to render a plurality of clip segments based on the result set.

One embodiment provides a method including applying a natural language processing algorithm thereby to enable identification of natural language variations between the search query and the media timeline speech.

One embodiment provides a method wherein two or more of the clip segments are defined from a single master clip based on operation of a speech-responsive segmentation algorithm.

A method according to claim 11 including: additionally processing the search query against the clip segment contextual data based on a second set of predefined search logic; and causing a user interface to enable shifting between a first result set based on the first set of predefined search logic and a second result set based on the second set of predefined search logic.

One embodiment provides a method wherein the user interface is configured to enable navigation of each result set along a first axial dimension, and navigation between the result sets along a second axial dimension.

One embodiment provides a method wherein navigation along the first axial dimension is continuous, and navigation along the second axial dimension is stepwise between result sets.

One embodiment provides a method including: applying a first set of filter conditions thereby to define a first result set; applying a second set of filter conditions thereby to define a second result set; and configuring a user interface to enable switching between the first result set and second result set.

One embodiment provides a method wherein the user interface is configured to enable navigation of each result set along a first axial dimension, and navigation between the result sets along a second axial dimension.

One embodiment provides a method wherein navigation along the first axial dimension is continuous, and navigation along the second axial dimension is stepwise between result sets.

One embodiment provides a method wherein the first set of predefined search logic is responsive to a content promotion algorithm.

One embodiment provides a device that is configured to execute a messaging interface that delivers a result set of clip segments in response to a search query, wherein the search query is enabled by a method as described above.

One embodiment provides a computer implemented method for enabling searching of clip segments stored in a content library, the method including:
maintaining access to a content library including a plurality of clip segments, wherein each clip segment includes:
(i) clip segment contextual data, the clip segment contextual data being representative of one or more media events experienced when the clip segment is rendered; and
(ii) clip segment attribute data, the clip segment attribute data being representative of non-event attributes of the clip segment, wherein the clip segment attribute data includes one or more conversation genre values;
receiving a search query, wherein the search query is derived from input at a client device via a messaging platform, wherein the search query is associated with an active conversation;
determining a conversation genre for the active conversation;
processing the search query against the clip segment contextual data based on a first set of predefined search logic; and
applying one or more filters in respect of a result set generated via the processing of the search query against the clip segment contextual data based on a first set of predefined search logic, wherein the filters are applied based on clip segment attribute data, and wherein the filters include at least one filter based on the determined conversation genre; and
causing a user interface at the client device to deliver a result set of clip segments based upon the processing of the query based upon the first set of predefined search logic and the one or more applied filters.

One embodiment provides a method wherein determining a conversation genre for the active conversation includes executing one or more analysis algorithms that analyse previous conversation text in the active conversation thereby to identify predefined words, phrases, and/or grammatical structures.

One embodiment provides a method wherein determining a conversation genre for the active conversation includes identifying a manual user selection of a conversation genre.

One embodiment provides a method including determining a plurality of predicted conversation genres for the active conversation, and delivering separate result sets of clip segments for the respective predicted conversation genres.

One embodiment provides a method including causing a user interface to enable shifting between a first result set based on a first predicted conversation genre and a second result set based on a second predicted conversation genre.

One embodiment provides a method wherein the user interface is configured to enable navigation of each result set along a first axial dimension, and navigation between the result sets along a second axial dimension.

One embodiment provides a method including: identifying a selected clip segment; and updating metadata associated with that clip segment based on the determined conversation genre.

A computer implemented method for configuring delivery of clip segments stored in a content library in response to a user query, the method including:
maintaining access to a content library including a plurality of clip segments, wherein each clip segment includes:
(i) clip segment contextual data, the clip segment contextual data being representative of one or more media events experienced when the clip segment is rendered; and
(ii) clip segment attribute data, the clip segment attribute data being representative of non-event attributes of the clip segment, wherein the clip segment attribute data includes one or more conversation genre values;
receiving a search query, wherein the search query is derived from input at a client device via a messaging platform, wherein the search query is associated with an active conversation;
processing the search query against the clip segment contextual data based on a first set of predefined search logic; and
applying one or more filters in respect of a result set generated via the processing of the search query against the clip segment contextual data based on a first set of predefined search logic, wherein the filters are applied based on clip segment attribute data, and wherein the filters include at least one filter based on the determined conversation genre;
applying a content promotion protocol thereby to cause upwards promotion of one or more clip segments in the result set; and
causing a user interface at the client device to deliver a result set of clip segments based upon the processing of the query based upon the first set of predefined search logic and the one or more applied filters.

One embodiment provides a method wherein applying a content promotion protocol thereby to cause upwards promotion of one or more clip segments in the result set includes: (i) identifying a promoted clip segment; (ii) determining a promotion level attribute associated with the promoted clip segment; and (iii) causing upward promotion of the clip segment based on the promotion level attribute.

One embodiment provides a method wherein identifying a promoted clip segment includes identifying a clip segment having prescribed metadata attributes.

One embodiment provides a method wherein the search engine is configured to apply a relevance score to each clip segment in a result set, and wherein the relevance score is affected by the content promotion protocol.

One embodiment provides a method including applying data derived from analysis of content utilisation/non-utilization thereby to limit delivery of promoted clip segments.

One embodiment provides a method including applying data derived from analysis of content utilisation/non-utilization thereby to control distribution of promoted clip segments within a result set.

One embodiment provides a method including applying data derived from analysis of content utilisation/non-utilization thereby to restrict presentation of promoted clip segments having greater than a threshold level of non-utilisation.

One embodiment provides a method wherein non-utilisation is determined based on analysis of clip segment and/or metadata attribute popularity scores.

A device that is configured to execute a messaging interface that delivers a result set of clip segments in response to a search query, wherein clip segments are delivered by a method according as described above

A computer implemented method for categorising of clip segments for a clip content library, the method including:
identifying an artefact identification algorithm, wherein the artefact identification algorithm is configured to identify a predefined artefact in media data;
applying the identified artefact identification algorithm across a plurality of clip segments;
in the case that a given segment is identified, by way of the artefact identification algorithm, to include the predefined media artefact, updating metadata associated with that clip segment with data representative of the presence predefined media artefact.

One embodiment provides a method wherein the artefact identification algorithm is an audio-based identification algorithm, which is configured to identify the presence of a predefined word or phrase in audio data associated with a given clip segment.

One embodiment provides a method wherein the artefact identification algorithm is a text-based identification algorithm, which is configured to identify the presence of a predefined word or phrase in text data associated with a given clip segment.

One embodiment provides a method wherein the artefact identification algorithm is an image-based identification algorithm, which is configured to identify the presence of predefined image characteristics in one or more frames of image data.

One embodiment provides a method wherein the image-based identification algorithm includes a facial recognition algorithm configured to identify the presence of a known face.

One embodiment provides a method wherein the image-based identification algorithm includes an object recognition algorithm configured to identify the presence of a known object.

One embodiment provides a method wherein the known object includes text.

One embodiment provides a method wherein the known object includes a logo.

One embodiment provides a method including configuring a content prioritisation algorithm to cause weighting and/or ordering of a set of clip segment search results based on the presence of one or more predefined media artefacts.

One embodiment provides a device that is configured to execute a messaging interface that delivers a result set of clip segments in response to a search query, wherein the result set is defined based on the content prioritisation algorithm as described above.

One embodiment provides a computer implemented method for categorising of clip segments for a clip content library, the method including:
identifying an artefact identification algorithm, wherein the artefact identification algorithm is configured to identify a predefined artefact in media data;
applying the identified artefact identification algorithm across a plurality of clip segments;
in the case that a given segment is identified, by way of the artefact identification algorithm, to include the predefined media artefact, updating metadata associated with that clip segment with data representative of the presence predefined media artefact.

One embodiment provides a method wherein the artefact identification algorithm is an audio-based identification algorithm, which is configured to identify the presence of a predefined word or phrase in audio data associated with a given clip segment.

One embodiment provides a method wherein the artefact identification algorithm is a text-based identification algorithm, which is configured to identify the presence of a predefined word or phrase in text data associated with a given clip segment.

One embodiment provides a method wherein the artefact identification algorithm is an image-based identification algorithm, which is configured to identify the presence of predefined image characteristics in one or more frames of image data.

One embodiment provides a method wherein the image-based identification algorithm includes a facial recognition algorithm configured to identify the presence of a known face.

One embodiment provides a method wherein the image-based identification algorithm includes an object recognition algorithm configured to identify the presence of a known object.

One embodiment provides a method wherein the known object includes text.

One embodiment provides a method wherein the known object includes a logo.

A method according to any preceding claim including configuring a content prioritisation algorithm to cause weighting and/or ordering of a set of clip segment search results based on the presence of one or more predefined media artefacts.

One embodiment provides a device that is configured to execute a messaging interface that delivers a result set of clip segments in response to a search query, wherein the result set is defined based on the content prioritisation algorithm of claim 9.

One embodiment provides a computer program product for performing a method as described herein.

One embodiment provides a non-transitory carrier medium for carrying computer executable code that, when executed on a processor, causes the processor to perform a method as described herein.

One embodiment provides a system configured for performing a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

As used herein, the term “exemplary” is used in the sense of providing examples, as opposed to indicating quality. That is, an “exemplary embodiment” is an embodiment provided as an example, as opposed to necessarily being an embodiment of exemplary quality.

### BRIEF DESCRIPTION OF THE DRAWINGS

Embodiments of the invention will now be described, by way of example only, with reference to the accompanying drawings in which:

FIG. 1A illustrates a framework according to one embodiment.

FIG. 1B illustrates a framework according to one embodiment.

FIG. 2A to FIG. 2E illustrate example clip processing techniques.

FIG. 3A to FIG. 3D illustrate example user interfaces.

FIG. 3E illustrates UI contextual data for one example.

FIG. 4 illustrates a system according to one embodiment.

### DETAILED DESCRIPTION

The present technology relates to frameworks and methodologies configured to enable generation of and management of content items available via a messaging interface. For example, embodiments include technology that enables automated generation and categorisation of sub-clips from one or more media source files. These sub-clips are then made available for searching and sharing via one or more instant messaging platforms (and/or other communications platforms). Embodiments also relate to search and retrieval technology applicable to media content items (including sub-clips defined by such a process applicable to source files, and to media items more generally).

### Context to Technology

Described herein is technology that, at least in some embodiments, is configured to support messaging platforms, thereby to enable generation and delivery of messages including video/animation data (referred to herein as “clip segments”). This video/animation data is maintained across one or more content libraries, and is for example accessed via a search interface embed within a user's messaging software application.

In the context of practical application, various forms of “clip messaging” are already known, and of significant popularity. Technologies described herein are directed to delivering a range of commercially useful outcomes, including enabling content suppliers (such as suppliers of film and television content) to derive significant benefits from clip messaging in the form of advertising and promoting their new titles and/or library product. As described herein, some embodiments provide advantages including:
(i) Automated Clip Content Generation. Technology described herein that enables content to be autonomously processed thereby to define a plurality of searchable and meaningfully tagged clip segments. This solves technical problems relating to automated processing and categorisation of content, and in a practical sense allows content suppliers to provide content and participate in the clip messaging platform arrangement with minimal effort.
(ii) Intelligent Promotion of Content: Leveraging clip categorisation and tagging technologies, content providers and other parties are able to cause clip content having particular attributes to be promoted in user search results above other content, for example to enable promotion of new content over catalogued content, to promote a particular new film or television show, and so on. This provides technical solutions in the context of enabling intelligent control over search and retrieval functionalities.
(iii) Capture of Content Utilisation Metrics. Utilisation (and in some cases non-utilisation) metrics are recorded and analysed, thereby to provide market insights into content that is popular, unpopular, trending, and so on. This is able to be broken down by reference to demographic information, thereby to enable better understanding of content popularity in a given marketplace. This is able to be useful in identifying the popularity of actors, snippets of dialogue, comedic and dramatic situations, storylines, the work of writers and directors, etc. This may be used to inform their future project development and project production decisions, and addresses technical problems associated with configuring a search engine to intelligently deliver results of highest potential relevance.
(iv) Automated Identification of Key Clip Artefacts. Algorithms are used to identify, in clip segment data, key clip artefacts, such as products/logos/brands/people. This is achieved by either or both of video and audio processing. For example, in one embodiment a video processing algorithm with image recognition functionality is configured to identify a particular company logo in clip segment data. This enables content promotion based on product placement and/or recording of viewer metrics thereby to enable analysis of brand exposure. Facial recognition, recognition of voices, recognition of words/phases, and other forms of media data processing are also optionally applied. This addressed technical problems in the context of automatically assigning attributes (e.g. metadata) to a significant amount of multimedia content automatically, for example in the context of populating and/or tagging a media content item library.
(v) Content Awareness via Personal Messaging: Content suppliers will be served by having clips excised from their material (filmed entertainment) used as personal messages (avatars of a sender) these clips will serve to market, advertise and promote their assets in a general sense, and bring to them, potentially, a level of top of mind awareness not otherwise obtainable.

It should be appreciated that, whilst the technology is described primarily by reference to application in the context of media and messaging, that the technological solutions provided by embodiments are applicable to broader contexts.

### Technology Overview

Technology is described below in the context of an implementation environment whereby users of one or more messaging platforms (for example instant messaging platforms accessed via mobile devices and/or via web-based interfaces) are enabled to send messages that include “clip segments” defined in a central clip segment content library. For example, via a messaging interface, a user submits a query, and this query is processed against the content library thereby to identify one or more clip segments of determined to be of relevance to the query. The user then selects one of these for delivery to one or more recipients, and the messaging interface causes client devices associated with the one or more recipients to render the selected clip segment (for example a software application associated with the messaging platform is caused to obtain clip segment frame data from a specified source at a future point in time).

As used herein, the term “clip segment” refers to a set of one or more media frames (typically a plurality of media frames ordered to be rendered in a predefined sequence), which are configured to be rendered in a sequential order thereby to display a video/animation. A clip segment is able to be defined via data in a wide range of file formats, including various video formats (including streamed formats), animated GIF formats, and the like.

It will be appreciated that the disclosure below focusses at times primarily on clip segments that are relatively shorter segments of a relatively longer source media file (also referred to as a “master clip”). For example, technology described below enables the generation of data representative of a plurality of clip segments from a given source media file, thereby to enable automated generation of a substantial searchable content library with limited manual effort. However, it should be appreciated that content libraries and messaging interfaces described herein are preferably configured to operate both with autonomously generated clip segments derived from master clips, and also purpose-defined clip segments (for example individual clip segments defined with manually inputted metadata and/or other contextual information).

In practical terms, generation of clip segments may include generating a plurality of short (2-10 second) clip segments from a movie, television program, or the like. These are categorised via automated processes thereby to enable contextual identification via user search queries. In some embodiments this is achieved via the use of media-associated text, for example subtitles or text derived from a speech-to-text conversion process. This allows, in a straightforward use-case, for a user to type a message (for example “would you like to get a coffee”) and be presented with multiple options of clip segments from movies, television, and the like, where words corresponding to that massage are spoken (i.e. “would you like to get a coffee” and natural language derived variants). The user then sends a message defined by or including a selected one of the clip segments (optionally in combination with the message text).

### Example Frameworks

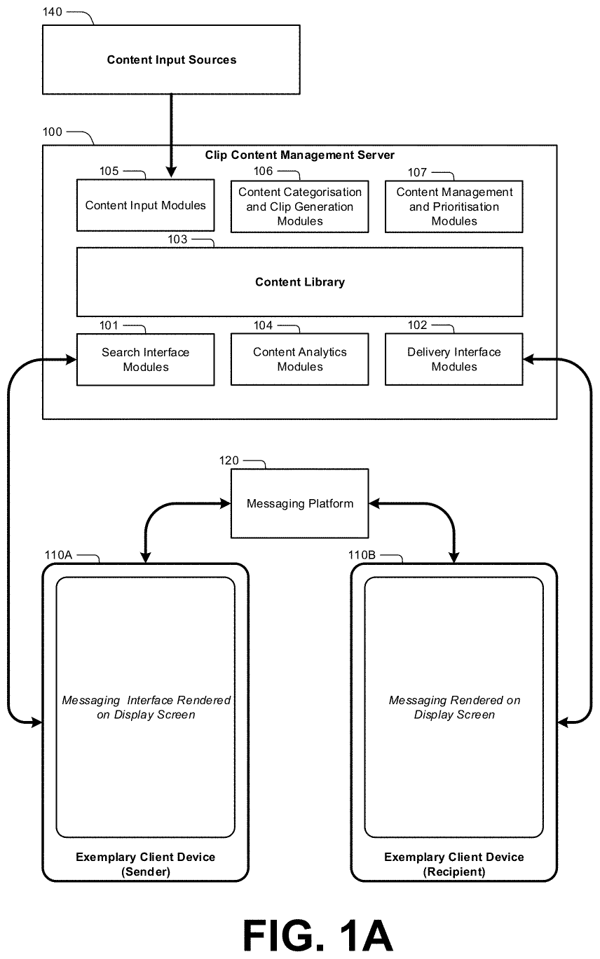

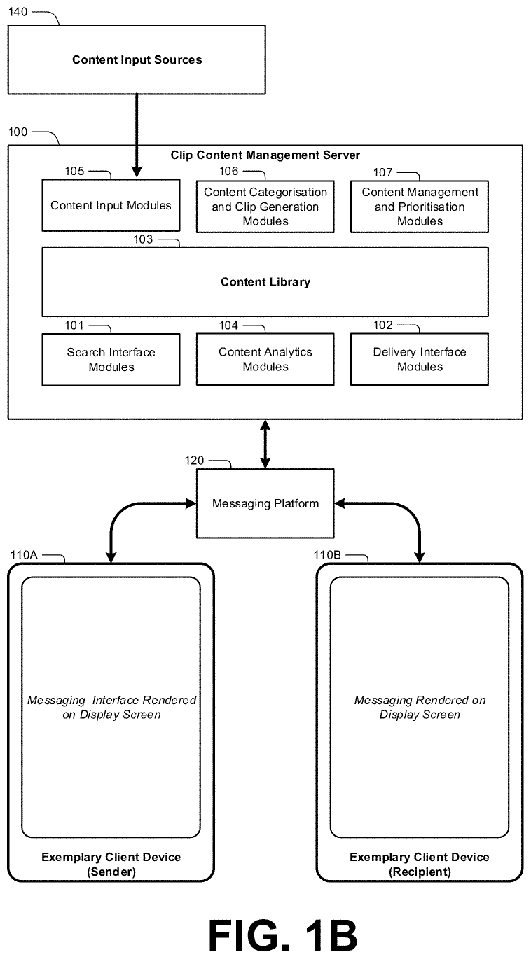

FIG. 1A illustrates a framework according to one embodiment. The framework centres upon a clip content management server 100, which is configured to enable generation and management of content items, which are referred to herein as “clip segments”. In overview, these clip segments are made available for sharing between users via a messaging platform 120, for example an instant messaging platform (which is defined by user interfaces rendered at two or more client terminals, and supporting network infrastructure that allows delivery of message data defined at one terminal to another one or more terminals).

Server 100 is described by reference to functional “modules”, which are in practical embodiments delivered via a plurality of executing software processes. The manner of description is functional for ease of understanding, and it not intended to be in any way limiting on software/hardware architecture and configurations used in embodiments.

The term “module” refers to a software component that is logically separable (a computer program), or a hardware component. The module of the embodiment refers to not only a module in the computer program but also a module in a hardware configuration. The discussion of the embodiment also serves as the discussion of computer programs for causing the modules to function (including a program that causes a computer to execute each step, a program that causes the computer to function as means, and a program that causes the computer to implement each function), and as the discussion of a system and a method. For convenience of explanation, the phrases “stores information,” “causes information to be stored,” and other phrases equivalent thereto are used. If the embodiment is a computer program, these phrases are intended to express “causes a memory device to store information” or “controls a memory device to cause the memory device to store information.” The modules may correspond to the functions in a one-to-one correspondence. In a software implementation, one module may form one program or multiple modules may form one program. One module may form multiple programs. Multiple modules may be executed by a single computer. A single module may be executed by multiple computers in a distributed environment or a parallel environment. One module may include another module. In the discussion that follows, the term “connection” refers to not only a physical connection but also a logical connection (such as an exchange of data, instructions, and data reference relationship). The term “predetermined” means that something is decided in advance of a process of interest. The term “predetermined” is thus intended to refer to something that is decided in advance of a process of interest in the embodiment. Even after a process in the embodiment has started, the term “predetermined” refers to something that is decided in advance of a process of interest depending on a condition or a status of the embodiment at the present point of time or depending on a condition or status heretofore continuing down to the present point of time. If “predetermined values” are plural, the predetermined values may be different from each other, or two or more of the predetermined values (including all the values) may be equal to each other. A statement that “if A, B is to be performed” is intended to mean “that it is determined whether something is A, and that if something is determined as A, an action B is to be carried out”. The statement becomes meaningless if the determination as to whether something is A is not performed.

The terms “system” and “framework” refer to an arrangement where multiple computers, hardware configurations, and devices are interconnected via a communication network (including a one-to-one communication connection). The term “system”, and the term “device”, also refer to an arrangement that includes a single computer, a hardware configuration, and a device. The system does not include a social system that is a social “arrangement” formulated by humans.

At each process performed by a module, or at one of the processes performed by a module, information as a process target is read from a memory device, the information is then processed, and the process results are written onto the memory device. A description related to the reading of the information from the memory device prior to the process and the writing of the processed information onto the memory device subsequent to the process may be omitted as appropriate. The memory devices may include a hard disk, a random-access memory (RAM), an external storage medium, a memory device connected via a communication network, and a ledger within a CPU (Central Processing Unit).

In the example of FIG. 1A, a client device 110A is operated as a “sender” device, in that a user of device 110A interacts with a messaging interface rendered on a screen of device 110A (for example based on software instructions executing on one or more processors of device 110A) thereby to send a message. This message includes (or is defined by) a sub-clip made available via server 100. The message sent by device 110A is delivered, via a messaging platform 120, to a client device 110B which acts as a “recipient” device (via execution of a compatible messaging interface executing and rendered at device 110B). The example of sender device 110A and recipient device 110B is intentionally simple, and it will be appreciated that the devices will typically take on both roles as sender and recipient in the context of a two-way messaging exchange (and furthermore that messaging may involve more than two participants).

The messaging platform may be substantially any form of messaging platform, including messaging platforms that execute within native software applications, and messaging platforms that execute based on computer executable code downloaded from the web and executed via a web browser application. Such platforms are often accessible by users of a range of client devices, including mobile devices (such as smartphones and tablets), PCs, wearables, gaming consoles, and so on.

In preferred embodiments, (In FIG. 1A) the messaging platform is a messaging platform inherently configured to operate without access to server 100, and is updated in functionality thereby to provide functionalities made available via server 100. For example, a widget or the like is added to the user interface rendered for the messaging platform at the client devices (in some embodiments this need only be made available at a sender device, with the recipient device being enabled to receive and view a clip segment without any user interface modification). Examples of user interface displays are provided further below.

In the example of FIG. 1A, a widget or the like executing at each client terminal 110A and 110B (for example executing within or in conjunction with a messaging application) enables that client terminals to communicate directly with server 100. In particular, the sender device 110A interacts with search interface modules 101, which are configured to: receive a search query from client device 110A; process that search query against a content library 103; and deliver search results to client device 110A. Recipient device 110B interacts with delivery interface modules 102, which are responsible for delivering to recipient device 110B data configured to cause rendering of the sender's selected clip segment at device 110B.

Alternately, as shown in the example of FIG. 1B, in some embodiments devices 110A and 110B do not communicate directly with server 100, but instead communications with server 100 are handled via messaging platform 120 as an intermediary.

In various embodiments described below, the clip content library is configured to make the data representative of the defined clip segments available for access via a messaging interface, such that the messaging interface is enabled to:
(i) perform a search thereby to identify a search result set including one or more clip segments, wherein the search is based upon a search query that is processed against clip segment contextual data;
(ii) enable the user to select a desired clip segment from the search result set; and
(iii) cause rendering at a recipient device of a set of frames from the media source associated with the selected clip segment time period.

Server 100 includes content analysis modules 104, which are configured to maintain data analytics with respect to clip segments. For example, this allows for analysis of trending content, clip segments that are undesirable (for example high search return rates but low usage rates, and other analytical functions. This is discussed in more detail further below.

Server 100 also includes content input modules 105. Content input modules 105 are configured to process content derived from content input sources 140, thereby to enable generation of clip segment data in content library 103. The content input sources preferably include a range of different sources, including media files received in various video file formats and media that is stored in an online location from which it is available for streaming. Content categorisation and clip generation modules 106 are configured to generate clip segment data from master clips, as discussed in more detail further below.

Content management and prioritisation modules 107 are configured to enable control over promotion of content. For example, in some embodiments content suppliers pay a premium to have clip segments derived from their content (and/or specific master clips) to be prioritised in search results. In practice, a straightforward use-case is to promote a particular TV series by having clip segments from that TV series prioritised in search results. Content promotion and prioritisation is also discussed in more detail further below.

### Streamlined Construction of Clip Content Library

Embodiments include computer implemented methods for generating a clip content library by autonomously (or substantially autonomously) generating clip segments from media sources, or “master clips”. In overview, the focus is to enable a streamlined process to extract meaningfully categorised clip segments (of about 2-10 seconds) from various content input sources (which are typically significantly longer).

There are technical problems associated with constructing such a library via non-manual means, given the huge amount of available content (for example the decades of television and movie content which could provide useful subject matter). Various embodiments of technology described below addresses such technical problems by enabling automated clip generation and classification using various data processing techniques. This also allows for efficient ingestion of new content, enabling content providers to simply provide their content (for example in file form, or via a link to an online streaming location) with only minimal context (for example metadata representative of the content name, content provider, and so on), and have that made available as a potentially large number of meaningfully categorised and searchable clip segments accessible via one or more electronic messaging interfaces.

In some embodiments, server 100 is configured to perform a method including receiving data representative of a media source, for example a media file or a link to a media streaming location. The media source is defined by a plurality of ordered image frames, including frames F₀ corresponding to a reference time T₀ and a frame Fₙ corresponding to a reference time Tₙ. Reference times T₀ and Tₙ are defined on a timeline.

The method also includes identifying media timeline contextual data associated with the media source, the media timeline contextual data including data correlated to a time period corresponding to the time period including T₀ to Tₙ. The term “media timeline contextual data” generally describes contextual data (such as metadata) which describes activity/content in media relative to the media timeline (for example using timecode information or the like). This may include information embedded within and/or extracted from the media itself, and/or information provided in a separate file (for example a log file).

The nature of media timeline contextual data varies between media sources. Examples include:
Textual information describing the media content on a time-specific basis. This is typically manually defined, for example via a timecoded log. Such data is helpful in categorising the meaning of content that is unrelated to speech (for example (TIMECODE XX:YY:ZZ to XX′:YY′:ZZ′—car explodes”).
Textual information derived from subtitles. This may include subtitles made available in a separate media file/stream, subtitles embedded in a given media file/stream, and subtitles extracted frame-by-frame using a text character recognition process. Subtitles are useful in associating media with context by reference to spoken words (and in some cases other attributes recorded in subtitles).
Textual information derived from speech recognition. In some embodiments, as an alternative to using predefined subtitles, a speech-to-text engine is used to enable association of media frames to spoken words (and text representative of those words). Whilst requiring more processing overheads than the use of pre-existing subtitles, this provides a more accurate association between speech and timing.

Various other forms of media timeline contextual data may also be used. For example, various artefact identification processes may be run over media data thereby to automatically extract content, for example using facial recognition, object recognition (e.g. brands, items, products, etc), audio profiling, and other such media processing technologies. This optionally extends to “on-the-fly” defining of media timeline contextual data based on operation of one or more media data processing algorithms.

In some embodiments a sub-process is performed to transform a timeline associated with the source media and a timeline associated with contextual data to a common frame of reference.

The method includes processing the media timeline contextual data and/or media data based on one or more segmentation algorithms, thereby to define a plurality of clip segments (which in some embodiments include overlapping segments). The segmentation algorithms are configured to identify delimiters in media content, and in various embodiments use inputs derived from:
Speech-based delimiters, for example changes in speaker, conversational delimiters, and the like.
Purpose-defined delimiters, for example where the contextual data includes textual information describing the media content on a time-specific basis.
Scene delimiters, for example where there is a greater than threshold inter-frame variation in pixels (representative of a change in scene, as opposed to continuance of an existing scene).
Third-party video analysis tools, for example tools configured to predict periods of “action” in video data (allowing automated identification of an “action commenced” and “action completed” delimeter).
Predefined time constraints (for example a maximum clip length, which is preferably set at 5 seconds or less).

In one embodiment a segmentation algorithm is configured to identify a set of delimiters in a media source file, and based on those delimiters define a set of sub clips based on: (i) delimited segments having a playback time period of less than a predefined threshold; and optionally (ii) combinations to sequential delimited segments that in combination have a combined playback time period of less than the predefined threshold.

Each clip segment includes clip segment contextual data derived from the media timeline contextual data. This, in effect, provides searchable metadata for the clip segment, with the nature of this metadata being reliant on the form of the contextual data. For example, in some cases the clip segment contextual data is text data representative of speech spoken during the clip segment (which may be stored as either or both of a literal transcription and a natural language processing abstraction of the literal transcription).

Media is also preferably associated with media static contextual data, being metadata applicable to the media as a whole, and not just discrete portions of the timeline. For example, this includes details such as: content title (for example the title of a film or song); content source (for example a film company or television series); content author (for example a producer/director/artist); classification rating; content type (for example “television show”, “film”, “advertisement” or “music video”); content genre (for example “mature comedy”, “children's comedy”, “action”, “documentary”, “romantic”, and so on). The clip segment contextual data preferably includes additional metadata derived from the media static contextual data. This is in some embodiments used to assist in filtering and/or narrowing of search results in response to a given query of clip segment data.

Each clip segment also includes data representative of a clip segment time period defined relative to the media timeline. As noted, a media source is defined by a plurality of ordered image frames, including frames F₀ corresponding to a reference time T₀ and a frame Fₙ corresponding to a reference time Tₙ. Reference times T₀ and Tₙ are defined on a timeline. For a given clip segment the clip segment time period is from Tᵢ to Tⱼ, wherein 0≤i≤j≤n.

Data representative of the defined clip segments is stored in clip content library 103. As noted, this clip content library in some embodiments additionally includes clip segments that are purposely manually defined on an individual basis.

There are a range of alternate approaches for managing and/or providing access to actual frame data for clip segments. In general terms, these approaches fall into three primary categories:
Approaches whereby frame data for individual clip segments is stored in a repository (such as library 103). This, in some embodiments, includes applying an extraction and processing method in respect of source media, thereby to define individual clip segment files. In some cases these are defined in a different format, resolution and/or frame rate to the source media. For example, the individual clip segment files may be animated GIF files generated by combining a subset of video frames from Tᵢ to Tⱼ. However, conventional video formats may also be used.
Approaches whereby clip segments are extracted from a master clip on an “as required” basis. That is, by way of example, a master clip runs from T₀ to Tₙ and a given clip segment from Tᵢ to Tⱼ, (wherein 0≤i≤j≤n), and an instruction to cause rendering of the clip segment includes data that causes streaming of frames corresponding to Tᵢ to Tⱼ from the master clip.
A hybrid approach, whereby individual clip segments are defined and stored only in the case that (when) a given clip segment reaches a threshold level of popularity (which, in some embodiments, is defined as a single utilisation via a messaging platform). By this approach, popular/useful clip segments are stored in a manner configured for efficient access and handling.

Further approaches are also used. For example, in some cases library-stored animated GIFs are used for the purpose of clip segment previewing during sender-device search functions, and higher quality video files (optionally streamed from a master clip web location) used for the purpose of recipient-device rendering. In some cases such intelligent utilisation of high quality and low quality rendering is applied to increase efficacy based on client device connect/bandwidth, client device type, and so on.

By the technologies described above, content providers are able to provide content in a wide range of forms (for example file formats, streaming locations, and so on) and have those automatically processed and converted into searchable clip segments for utilisation via messaging platforms.

In some embodiments, means are implemented thereby to perform preliminary trimming of master media content, thereby to distinguish between: portions of the master media content that are to be considered for clip segment generation; and portions that are to be excluded. This may be achieved by either or both of manual techniques (for example timecode-based marking) and automated techniques (for example media processing algorithms which are configured to identify key scenes based on predefined rules). This may be in combination or addition to delimiter-based segmentation algorithms disclosed above.

Example End-to-End Processes for Clip Segment Generation from Master Clips

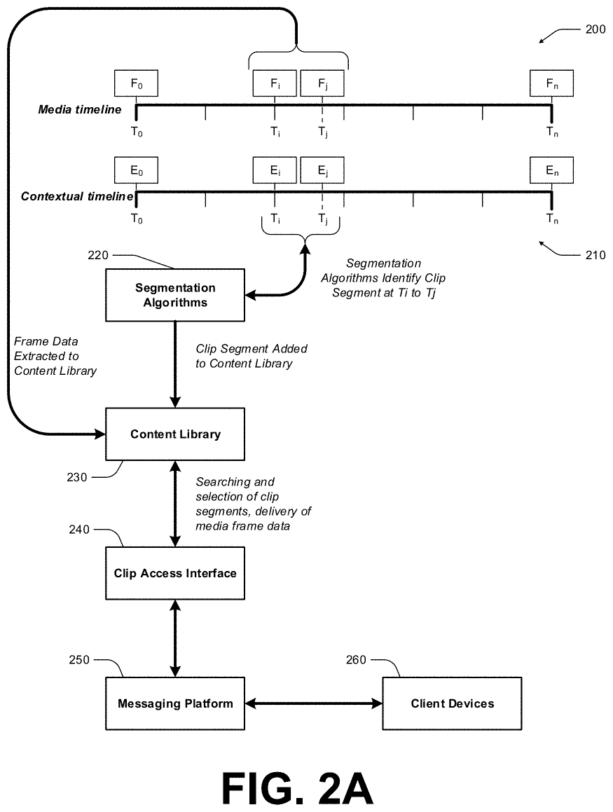

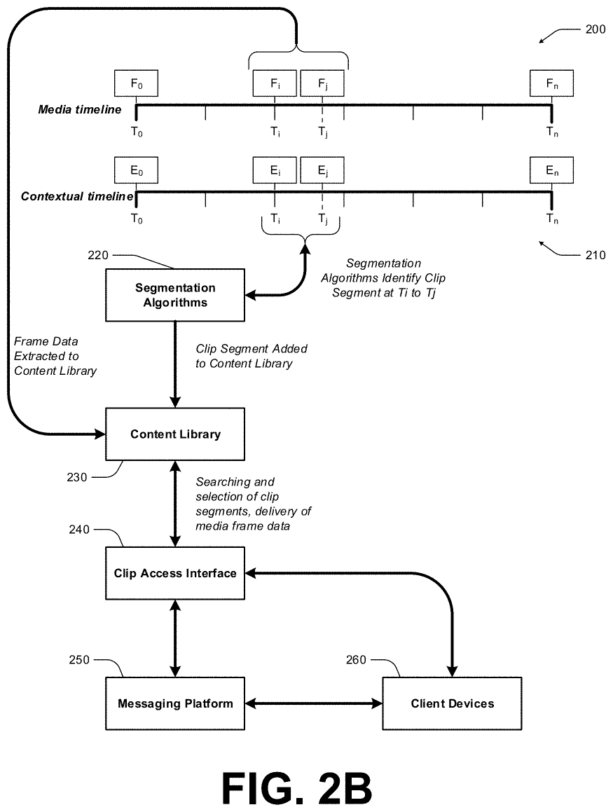

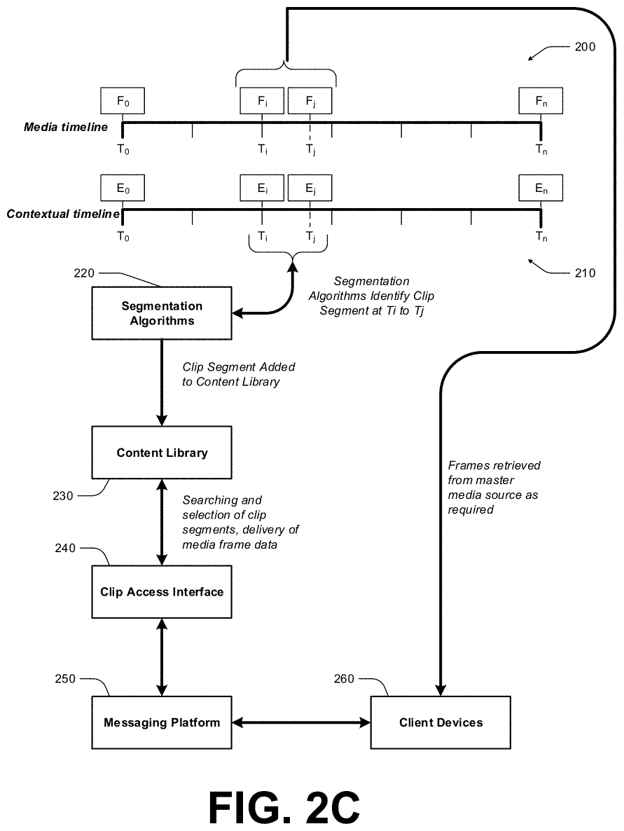

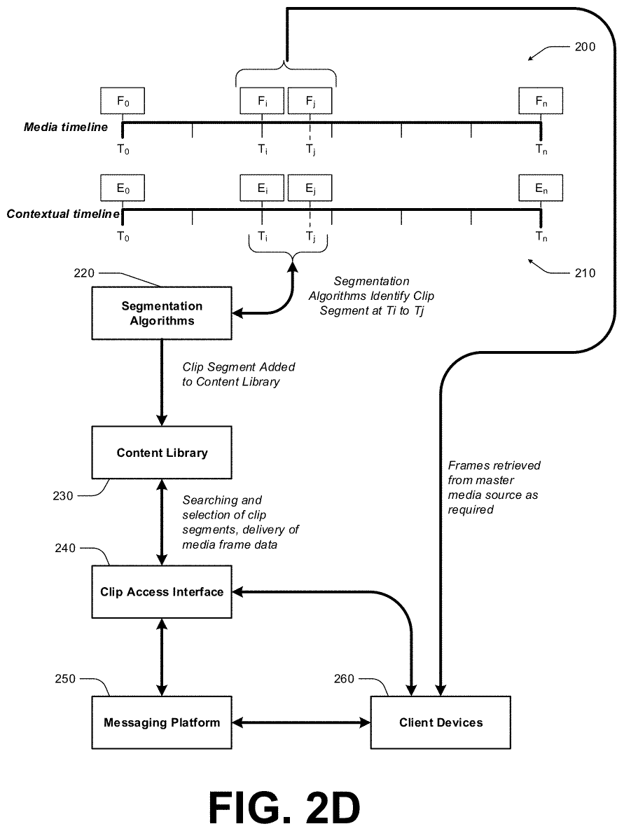

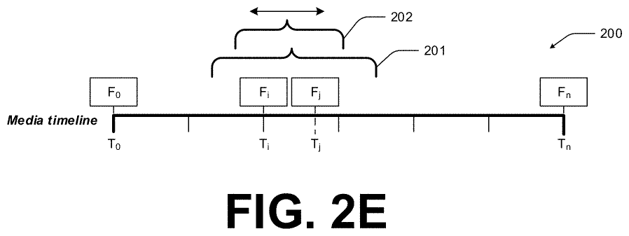

FIG. 2A to FIG. 2D illustrate example end-to-end processes according to various embodiments. In these examples, a media file 200 is defined on a media timeline; this may for example be a locally stored file or a remotely hosted streaming media file. Contextual data 201 is defined on a contextual data timeline (which may be the same as the media timeline). For the sake of this example, both timelines run from corresponding reference times T₀ to Tₙ. The contextual data may include any one or more of: data associated with the media (such as an event log), data embedded in the media (for example embedded subtitles) and data derived from processing of the media (for example extracted events and/or speech identified by a speech-to-text converter). In this example the media timeline runs from a frame F₀ to a frame Fₙ, these corresponding to events E₀ and Eₙ on the contextual data timeline.

Segmentation algorithms 220 are configured to process contextual data and/or media data thereby to define clip segments. As noted, these segmentation algorithms are configured to identify delimiter events, for example by reference to speech (for example sentence/conversation identification using text and/or audio), scenes (for example identifying scene delimiters), and so on. This results in the generation of a plurality of (potentially overlapping) clip segments of within a predefined threshold length (for example between 2 and 10 seconds). Data representative of the clip segments is stored in a content library 230. In this example, a clip segment is defined by a period from Tᵢ to Tⱼ, which is delimited by events Eᵢ and Eⱼ in the contextual data and frames Fᵢ to Fⱼ in the media data.

In the examples of FIG. 2A and FIG. 2B, for each clip segment defined by operation of segmentation algorithms 220, frame data is extracted from media data 200 to content library 230. This process in some embodiments includes defining clip segment media data in a different format to media data 200, for example by any one or more of: extracting only a subset of frames from Fᵢ to Fⱼ, applying compression (or other processing) to one or more extracted frames; and file format conversion. For example, in some embodiments media data 200 is encoded in a VP9 format and made available for streaming from an online location, and a subset of frames from Fᵢ to Fⱼ are extracted and compiled to generate an animated GIF file (which is stored in content library 203).

In the examples of FIG. 2C and FIG. 2D, frame data for individual clip segments is not extracted upon segmentation for storage in content library 230, and is instead directly obtained from media data 200 by a client device 260 on an as-required basis (e.g. when that device is caused to obtain and render a clip segment in response to a clip segment based message from another client device).

In the examples of FIG. 2A to FIG. 2D, client devices 260 interact with a messaging platform 250, thereby to communicate with one another. The client devices may interact with messaging platform 250 via different .local software applications, including proprietary applications and web-browser delivered messaging interfaces. Via messaging platform 250, client devices 260 are enabled to interact with a clip access interface 240. This interaction includes, for a sender device:
(i) Performing a search thereby to identify a search result set including one or more clip segments from content library 230. The search is based upon a search query that is processed against clip segment contextual data. In some cases the search query is defined by or includes proposed message text (it will be appreciated that a user is enabled to define a search query based on that or another approach).
(ii) Enable the user to select a desired clip segment from the search result set. In some embodiments the user is enabled to filter/refine search results via one or more additional inputs, for example by filtering on content type, content genre, content tone, and the like.
(iii) Providing an instruction to cause rendering at a recipient device of the selected clip segment. This is, in some embodiments, a “message send” instruction.

A recipient device then receives data that enables rendering of the clip segment. This may include: data representative of clip segment frames; a link that enables downloading of clip segment frames from content library 230 (see FIG. 2A and FIG. 2B); or a link that enables streaming of clip segment frames from media data 200 (see FIG. 2C and FIG. 2D).

### Clip Segment Fine-Tuning

It will be appreciated that even highly specialised segmentation algorithms will often define sub-optimal start and end points for clip segments. By way of a practical example, there may be occasions where segmentation algorithms define a clip segment based on the end of a sentence and a scene transition, but the subjective humour of the broader media is derived from a subsequent scene without speech. Noting this, some embodiments provide functionality to enable end users to fine-tune clip segments by adjusting either or both of a start time and an end time.

In one embodiment, segmentation algorithms identify a clip segment from Fᵢ to Fⱼ, but a buffered clip segment is defined including a preceding and following buffer portion (as shown by bracket 201 in FIG. 2E). This allows a user to position a cropped clip segment selector (which is, for example, controlled by a GUI slider) represented by bracket 202 relative to the buffer portion. In a further embodiment, a user is provided with more comprehensive editing tools, which allow controlling of a start and end time for a clip segment.

In some embodiments, at least a selection of user clip segment fine tuning operations become persistent. That is, assume based on segmentation algorithms a clip segment is defined from Fᵢ to Fⱼ, and a user performs fine-tuning editing to customise this segment to be defined from Fᵢ to Fₖ prior to sending. In the case that predefined conditions are met, the clip segment in library 230 is persistently modified to be defined from Fᵢ to Fₖ. The predefined conditions vary between embodiments; these may be based upon: (i) a user editing operation prior to the first utilisation of a clip segment; and/or (ii) multiple users performing similar editing operations.

### Example Messaging Interfaces

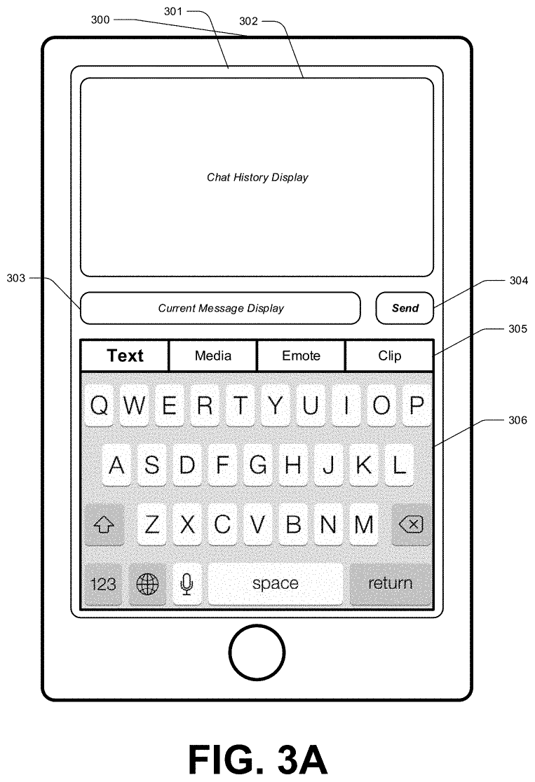

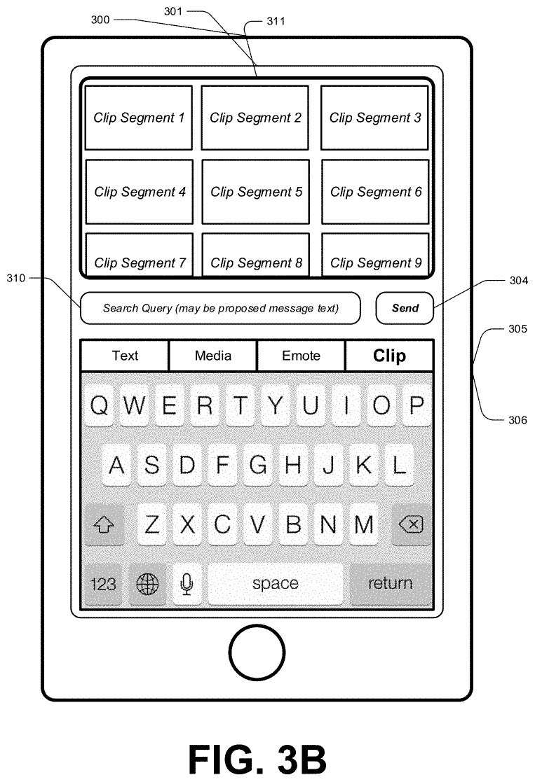

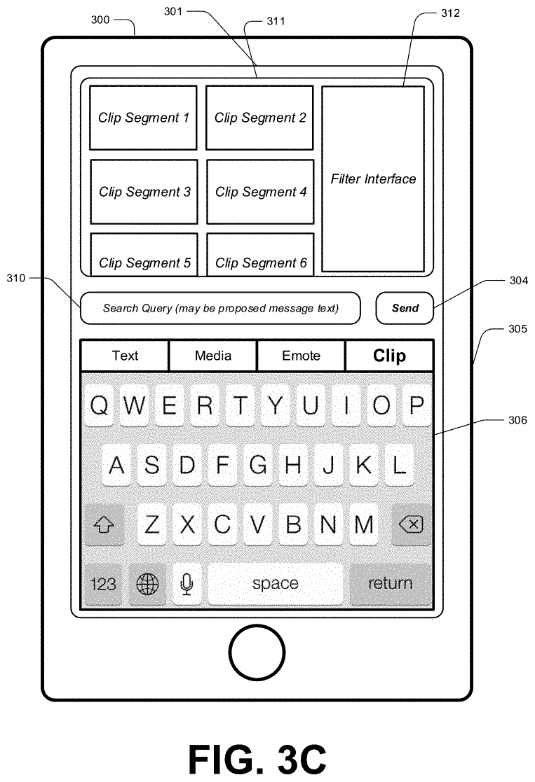

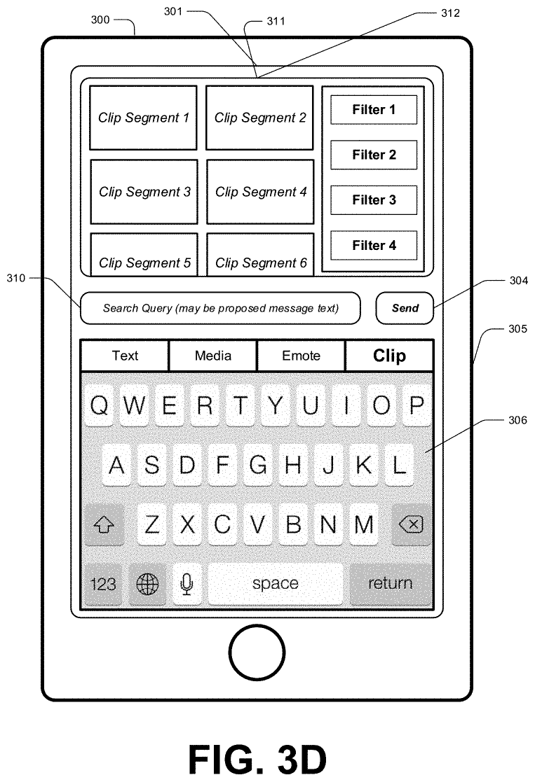

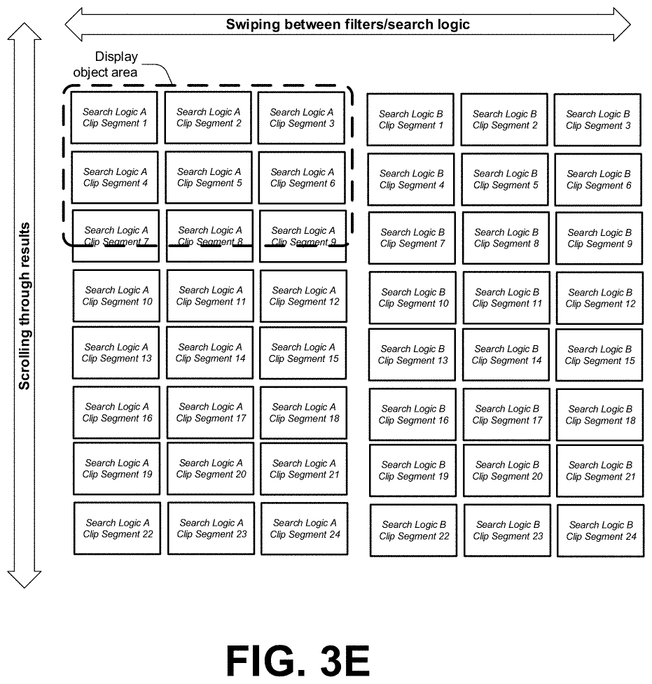

FIG. 3A to FIG. 3D illustrate example messaging interfaces. It will be appreciated that these are intended to be representative only, and intentionally omit various stylistic attributes that are present in various embodiments. That is, the illustrated interfaces are provided in a manner to assist in understanding core user interface functionalities.

FIG. 3A illustrates a relatively generic messaging interface rendered on a display screen 301 of a mobile device 300. This messaging interface includes a chat history display 302, which renders past messages in an active conversation (in this case including exchanged clip segments). A current message authoring object 303 displays text of a current message (generated via keyboard 306, or alternately by other input means such as voice commands) prior to that message being finalised and sent by operation of “send” button 304. An input selection interface 305 enables a user to select a message content type, in this case being “text” (currently selected), “media” (such as locally-stored photos and videos), “emote”, and “clip”. In the present context, it is the “clip” option that is of most relevance; this provides access to functionality to search, select, and send clip segments within the messaging interface.

In some embodiments the “clip” option is an inherent part of a messaging application (for example a messaging application that is purpose-built for chatting primarily via clip segments). In other embodiments the “clip” option is integrated into an existing messaging application as part of a software update thereby to provide clip segment messaging functionalities as an add-on. In the case of the latter, as noted above thee are embodiments where such functionalities are made available via direct interaction with a clip segment management server, and indirect interaction with such a server via the relevant messaging platform.

FIG. 3B illustrates an example messaging interface with the “clip” option selected. With this selected, message authoring object 303 is replaced with a search query interface 310. In some embodiments this retains functionality as a message authoring object, for example where a proposed message is to be used as a search query (in some embodiments a user is able to author a message in object 303, select the “clip” option, and have that authored message transposed automatically to object 310).

In some embodiments, the search query is inputted in natural language (for example via keyboard and/or voice-based input), and a natural language processing algorithm is used to enable natural language based matching of the query string with clip segment data. For example, a search for “would you like to get coffee” would match with natural language variants such as “let's get coffee”, “do you want a coffee”, and so on. In other embodiments alternate text based searching algorithms are used in addition and/or as alternatives.

Regardless of the precise search logic used, in response to the input of data in object 310 (and preferably in response to ongoing modification of that data), a result set of clip segments are displayed in a result display object 311. In some embodiments these are instantiated for playback (for example as low resolution animated GIF files) immediately, and play on loop. In the illustrated embodiment additional search results are able to be viewed subject to a vertical scrolling gesture. A user clicks (e.g. via a touchscreen tap) a desired result to select that clip segment, and clicks the “send” object thereby to cause rendering of that clip segment (including in some cases a higher resolution or alternate data format variation thereof) at a recipient client device. The sent clip segment also subsequently appears in chat history display object 302.

In some embodiments, a user is enabled to make substantive changes to the result set. For example, one approach is to use a vertical scrolling gesture to enable scrolling of results based on a current search, and a horizontal swipe gesture to cause re-engineering of the search logic thereby to generate a new result set. For example, in such embodiments there are multiple sets of searching logic available (natural language, pure text, those favouring media static contextual data, and so on), and this horizontal swipe functionality shifts between those (in some embodiments in a randomized manner). This allows a user to achieve an instant re-engineering of a search without changing the search query. In preferred embodiments a learning algorithm is implemented thereby to enable either or both of: local learning of a given user's preferred form of searching (i.e. search logic is adjusted based on the sorts of results a user likes based on his/her query); and global learning based on search logic favoured on a broader basis.

Another means for enabling a user to adjust a result set is to provide a filtering interface. Examples are provided in FIG. 3C and FIG. 3D, which illustrate exemplary filtering interfaces 312. Preferably, the filtering interface provides a plurality filter options, which may be based upon media static contextual data. For example, a result set in this manner is able to be filtered based on attributes such as: content type (for example “television shovel”, “film”, “advertisement” or “music video”); content genre (for example “mature comedy”, “children's comedy”, “action”, “documentary”, and “romantic”); and so on. In some embodiments a user is enabled to scroll vertically between filter criteria for a given filter type, or swipe horizontally between filter types (see FIG. 3E as an example).

In some embodiments the filter enables a user to input a text-based query that filters a search based on the media static contextual data, for example by searching for “Star Wars”. This enables a user to identify Star Wars related content relevant to a natural language search query, and hence identify one or more instances in Star Wars content where a character spoke lines corresponding to the user's search query. In some cases such a filter is pre-applied (i.e. applied prior to input of the search query, for instance being set as a temporary default for a particular user and/or particular conversation). It should be appreciated that this is a use case example only, and the example of Star Wars does not imply any permission or affiliation (it is used purely as a contemporary popular culture reference).

FIG. 3E provides a graphical representation of an embodiment where vertical scrolling is used to enable viewing of results within a current result set (for example a result set based upon a given set of search logic and/or filters) and horizontal swiping between result sets (for example distinct result sets based on respective sets of search logic and/or filters). The vertical scrolling is continuous, whereas the horizontal swipe is step-wise between result sets. In some embodiments a user is enabled via a “settings” interface to personalise configuration of the effect of horizontal swiping, for example thereby to, for example: (i) provide convenient access to preferred filters (for example a “television” filter, a “Star Wars” filter, complex filters built using Boolean operators such as “movies AND comedy”, and/or conversation genres as discussed below).

### Conversation Genre Based Filtering

As noted above, some embodiments enable searching of clip segments based upon a combination of media timeline contextual data (for example using a natural language query which is processed to locate clip segments based on relevance of those segments to the natural language query) and media static contextual data (for example using a search filter based on the likes of content type, genre, title, and so on).

In some embodiments, an additional/alternative layer of filtering is implemented based upon “conversation genre”. In overview, the term “conversation genre” is used to objectively categorise the “tone” of a conversation. For example, conversation genres may include “flirtatious”, “romantic”, “professional”, “low-brow”, and so on. This provides a technical solution to technical problems associated with identifying search results of the greatest relevance in an efficient and effective manner, for example taking into consideration limited screen area and UI functionality typically available for a review of a large set of results (for example on a smartphone interface only around 2-5 of results are able to be displayed at a given point in time).

Clip segments are associated with metadata representative of one or more conversation genres, based on either or both of media timeline contextual data and media static contextual data. In some embodiments that metadata is updated over time based on use and/or non-use of particular clip segments in conversations of known (or predicted) conversation genre. As used herein, the term “non-use” refers to instances where a given clip segment is displayed but passed over (i.e. not used) in search results. Where a given clip is systematically non-used, search logic is configured to either: (i) apply a weighting so that it appears lower in results; or (ii) adjust metadata.

Determinations of conversation genre are in some embodiments made subject to a direct user selection (for example a user interacts with a user interface object thereby to directly select a conversation tone, which has an effect of pre-filtering clip segment results based on that selected tone). In other embodiments, a conversation genre prediction algorithm is implemented thereby to make automated predictions as to conversation genre. For example, such an algorithm is configured to monitor for particular words, phrases, and grammatical constructions (and/or conversation context) thereby to enable such a prediction. In a practical use case, such an algorithm may predict a “flirtatious” conversation, and hence filter clip segment search results to favour results containing “flirtatious” conversation genre metadata. Preferably a user is enabled to manually alter a predicted conversation genre. Again, horizontal swiping may be used as shown in FIG. 3E to shift between conversation genres.

### Content Prioritisation Via Promoted Content Management Engine

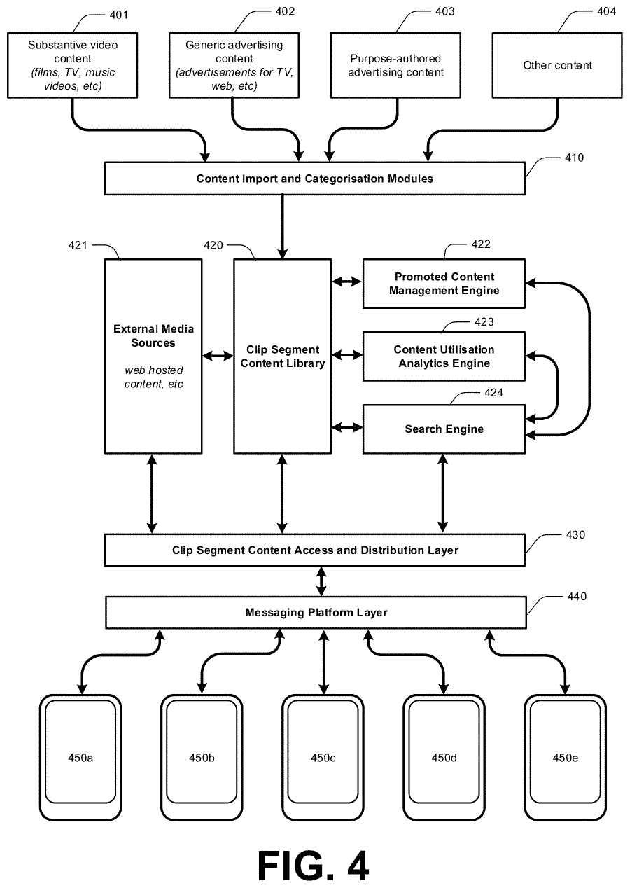

Some embodiments include methods for enabling distribution of content based on content promotion algorithms in the context of a clip segment supported messaging environment. This preferably leverages technologies described above, and example embodiments are described by reference to FIG. 4. Content prioritisation as described below is used to address technical problems associated with identifying preferred search results in a scenario where a user interface is able only to display a small number of results (for example 2-5) on-screen concurrently.

In the example of FIG. 4, clip segment data is derived from a range of sources. These include:
Substantive video content 401, such as TV shows, films, music videos, film trailers and the like. This is processed to define clip segment data based on technologies such as those described further above.
Generic advertising content 402, such as advertisements generated for television and/or web distribution. Again, this is processed to define clip segment data based on technologies such as those described further above.
Purpose-authored advertising content 403. This is content purposely authored to provide clip segments intended for distribution via the present framework, and is in some cases fully or partly pre-categorised with metadata by the content author. This allows advertisers and the like to make strategic use of the platform, for example by providing entertaining clip segments which are optimised based on factors such as: (i) known popular searches; (ii) search keyword optimisation; (iii) known forms of popular and/or trending content; and (iv) other factors.
Other content 404, for example content imported from pre-existing categorised GIF libraries and the like.

Content is received via content import and categorisation modules 410, and processed for importation into clip segment content library 420. As noted above, in some cases content library 420 operates in conjunction with external media sources 421, for example web sources from which streaming content is available (in some embodiments clip segments are deliverable as either or both of: animated GIFs derived from frames extracted from streamed content; and timecode limited portions of streamed content directly from a streaming source).

A promoted content management engine 422 is configured to enable content providers to exercise control over prioritisation of their content (including specified subsets of their content) within library 420. Specifically, promoted content management engine influences the operation of a search engine 424 and/or modifies content promotion metadata associated with clip segments in content library 420. In this regard, any clip segments in content library 430 are able to be treated as promoted content, and be upwardly promoted in search results beyond the extent to which they would otherwise be ordered subject to ordinary search engine operation.

The precise manner by which content promotion is implemented varies between embodiments, and it will be appreciated that a wide range of approaches for managing promoted content in search engine environments are well known in the art. By way of example, embodiments optionally implement any one or more of the following approaches:
Content relevance enhanced weighting. In embodiments where search results are ranked based on a relevance percentage (for example a result is a 80% match, 60% match, and so on), content is promoted by applying a weighting to that percentage (for example promoted content has its match percentage up-scaled by a defined percentile or proportion).
Content promotion based on specified search terms. For example, an advertiser may in exchange for a premium fee become associated with the keyword “coffee”, and have specified content promoted whenever a user's search contains the keyword “coffee”.
Content promotion via filter avoidance. For example, promoted content may be deemed relevant to a given search even in spite of user-defined filters which are not satisfied by a promoted clip segment's metadata.

Search engine 424 is in preferred embodiments configured to limit the number and/or proportion of promoted content results in a search result set. For example, where the result set includes greater than a threshold number of promoted content results (or greater than a threshold number of a results of a particular promoted content category), these may be filtered based on an algorithm (such as a random selection algorithm), and in some embodiments are distributed throughout the order of a result set in accordance with a defined protocol.

### Content Utilisation/Non-Utilisation Analytics

In some embodiments, search engine 424 is configured to make use of data derived from content utilisation analytics engine 423 thereby to enable either or both of: prioritization of actual/predicted popular content; and de-prioritisation of actual/predicted unpopular content. This is optionally achieved by way of a monitoring process which identifies (i) clip segments that are utilised; and (ii) clip segments that are presented to users (e.g. rendered at client devices within a result set) but not utilised. This is used to address technical problems associated with identifying search results of the highest predicted relevance, which as noted above is of great importance in UI scenarios where screen space to display results is limited (which is the case in messaging interfaces, particularly those used on smartphones).

In some embodiments, analytics engine 423 is configured to monitor clip segment utilisation, thereby to maintain data representative of actual and/or predicted popularity. This optionally includes updating a popularity score for each clip segment based on utilisation and non-utilisation. For example, each time a clip segment is rendered in a result set (i.e. rendered on-screen) and selected, the popularity score is increased by a predefined quantum. Likewise, each time a clip segment is rendered in a result set (i.e. rendered on-screen) and not selected, popularity score is decreased by a predefined quantum. The quantum of decrease is in some embodiments variable based on user activity attributes, for example by setting different quantum of decrease rules for any one or more of the following scenarios:
A rule where a clip segment is presented, but a higher ranked clip segment is selected.
A rule where a clip segment is presented, but a lower ranked clip segment is selected.
A rule where a clip segment is presented, but a user-initiated change in search logic/filtering is initiated (e.g. a horizontal swipe in the example of FIG. 3E).

Additional logic is optionally incorporated to assist in differentiating between anecdotal non-utilisation and systematic non-utilisation.

It will be appreciated that, over time, maintaining of popularity scores in this manner enables identification of unpopular/underutilised content. Search algorithms are then configured to restrict or control presentation of clip segments of lower than a threshold popularity score.

Whereas some embodiments define popularity scores on a segment-by-segment basis, other embodiments additionally/alternately define popularity scores based on clip segment metadata for non-event attributes. For example, where a clip segment is selected, this causes an across-the-board increase in popularity score for clip segments sharing common metadata for non-event attributes. So as to provide a use case, assume a given clip segment has metadata for non-event attributes including “Star Wars”, and that clip segment is selected, that causes an increase in popularity score for the metadata attribute “Star Wars”, and hence causes an increase in popularity score for all content having that metadata attribute.

Popularity scores are in some embodiments implemented in an additionally advanced manner, for example:
Personalisation of popularity scores based on individual user activity. For example, clip segments are filtered for a given user based on observations of that user's past selections (in that conversation and/or in other conversations).
Personalisation of popularity scores based on collective user activity for users active in a current conversation. For example, clip segments are filtered for a given conversation based on observations of the conversation participants' past selections (in that conversation and/or in other conversations).
Setting/control of popularity scores based on filters and the like (such as conversation genre). For example, a given clip segment or metadata attribute may have different popularity scores for different conversation genres.

In some embodiments search engine 424 is configured to implement an algorithm that utilises a plurality of popularity score types (for example based on the three examples directly above, and/or individual content vs global metadata based popularity) and applies respective weightings to the various scores thereby to provide input to an algorithm that determines clip segment ordering in a result set.

### Content Promotion Control Responsive to Utilisation/Non-Utilisation Analytics

In preferred embodiments, content utilisation analytics engine 423 is configured to exercise additional influence on promoted content. In overview, this is configured to enable execution of an algorithm that operates to: (i) identify underutilised promoted content; and (ii) place limitations on promotion of underutilised content. The general principle is to reduce the likelihood of unpopular promoted content overwhelming result sets, again in response to technical problems associated with causing presentation of search results having highest predicted relevance to a given query.

In some embodiments, this functionality is achieved by way of maintaining popularity scores, as discussed above. Search algorithms are then configured to restrict or control presentation of clip segments of lower than a threshold popularity score (which, as noted, can be affected by search parameters such as conversation genre). In this regard, “control” may include distributing promoted content having predefined (relatively low) popularity attributes throughout a result set, where that content would otherwise congregate at the top of the result set.

It will be appreciated that content promotion control responsive to utilisation/non-utilisation analytics in some cases operates to inhibit successful paid promotion of unpopular content; this is an intentional effect mindful of maintaining optimal user experience. In some embodiments content providers are provided reports on their content popularity, and also on content popularity more generally thereby to enable the generation/promotion of potentially more popular content.

### Clip Segment Analytics and Reporting

Content utilisation engine 423 is in some embodiments configured to provide reports based on clip segment utilisation, non-utilisation, and optionally more detailed characteristics of utilisation/non-utilisation (for example user demographics, context of utilisation, causational searches, and so on).

It will be appreciated that there are numerous ways in which analytics are able to assist content providers. Some representative examples are considered below:
Providing reports on trending content, and attributes thereof. This assists, for example: generation of purpose-authored content in response to observations of current trends; and (ii) identification of popular content that might be successfully monetised outside of the framework. In relation to the latter, as a straightforward use case, an observed trend to use clip segments from an old and obscure television series might prompt efforts to revive that series in some form.
Providing reports that associate demographic information and clip segment popularity. This, for example, assists a content author in defining purpose-authored clip segment content tailored to particular demographics.
Providing reports representative of common search queries, thereby to assist content authors in generating and/or promoting content that will be more commonly presented to users.

These are examples only, and not intended to be in any way limiting on the functionality of monitoring, collecting and/or utilising analytics in frameworks as herein described.

### Automated Subject Matter Identification and Tagging

In some embodiments, media artefact identification is implemented thereby to enable automated identification of various forms of significant subject matter within clips and/or clip segments. This assists in addressing technical problems associated with tagging (assigning metadata to) content in an automated manner, thereby to assist in efficient and effective search and retrieval. For example, this is may be used in the context of promoting clip segment content based on product placement (for example by automated identification of products and/or brands via audio and/or video processing). There are additional usages, for example categorizing clip segments based on identified actors, and so on.

From a commercial standpoint, technology described in this section is of assistance in clip segment content promotion, ongoing monetisation of paid product placement (for example where product placement in a clip was subject to a commercial product placement arrangement in the originating master content), data analytics (for instance identifying popular actors), and other such purposes, including the user messaging functionality.

As noted above, in some embodiments a method includes identifying media timeline contextual data associated with the media source, the media timeline contextual data including data correlated to a time period corresponding to the time period including T₀ to Tₙ. The term “media timeline contextual data” generally describes contextual data (such as metadata) which describes activity/content in media relative to the media timeline (for example using timecode information or the like). This may include information embedded within and/or extracted from the media itself, and/or information provided in a separate file (for example a log file).

Examples of media timeline contextual data described above include textual information based on a timecoded log, and textual information related to spoken content (for example derived from closed captioning, subtitles and/or voice recognition). In further embodiments, additional artefact identification algorithms are executed over clip and/or segment data thereby to identify the presence of defined media artefacts. This allows for clip segments to be tagged in metadata thereby indicating the presence of one or more predefined artefacts.

The nature of artefact identification algorithms varies between embodiments, for example depending on the nature of media artefact that is to be identified. For example:
In some examples the artefact identification algorithm is a text-based identification algorithm, which is configured to identify the presence of a predefined word or phrase in text data associated with a given clip segment. For instance, the word may be a name or a person or place, a product name, a brand name, or the like.
In some examples the artefact identification algorithm is a non-text based word identification algorithm, which is configured to identify the presence of a predefined word or phrase in non-text data associated with a given clip segment (for example via processing of audio data). For instance, the word may be a name or a person or place, a product name, a brand name, or the like. In further examples this extends more broadly to sound identification.
In some examples the artefact identification algorithm is an image-based identification algorithm, which is configured to identify the presence of predefined image characteristics in one or more frames of image data. For instance, the image-based identification algorithm includes a facial recognition algorithm configured to identify the presence of a known face (so as to enable tagging of clip segments based on people shown in those segments). Alternately, the image-based identification algorithm may include an object recognition algorithm configured to identify the presence of a known object (for example a brand logo, words displayed on-screen, and so on).

A wide range of artefact identification algorithms suitable for the above example purposes are known in the art. The present disclosure is not to be limited by reference to any particular artefact detection algorithms; during implementation a technician with knowledge of the artefact being sought will as a matter of routing identify a suitable image/audio/text processing algorithm.

Artefact identification algorithms may be applied at various stages, for example: against media prior to segmentation (optionally providing input to a segmentation algorithm); following segmentation; or to stored clip segments which may or may not have been defined via a segmentation process (for example a repository of clip segments defined my methods other than those described herein).

An example embodiment provides a computer implemented method for categorising of clip segments for a clip content library, the method including: identifying an artefact identification algorithm, wherein the artefact identification algorithm is configured to identify a predefined artefact in media data; applying the identified artefact identification algorithm across a plurality of clip segments; and in the case that a given segment is identified, by way of the artefact identification algorithm, to include the predefined media artefact, updating metadata associated with that clip segment with data representative of the presence of the predefined media artefact. The method preferably includes configuring a content prioritisation algorithm to cause weighting and/or ordering of a set of clip segment search results based on the presence of one or more predefined media artefacts.

Such a method allows clip segment prioritisation (for instance as described above) to be influenced by the presence of predefined media artefacts, such as brand names and/or brand logos. As a practical example, one approach is to promote clip segments containing predefined artefacts associated with a particular business/brand in exchange for a content promotion payment. This is optimally enhanced by way of keyword associations which causes such brand-relevant content to be delivered for certain non-precise search result matches.

### CONCLUSIONS AND INTERPRETATION

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. Input devices may also include audio/video input devices, and/or devices configured to derive information relating to characteristics/attributes of a human user. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A computer implemented method for generating a clip content library, the method including:
receiving data representative of a media source, wherein the media source is defined by a plurality of ordered image frames, including frames F₀ corresponding to a reference time T₀ and a frame F₀ corresponding to a reference time Tₙ, wherein reference times T₀ and Tₙ are defined on a timeline;
identifying media timeline contextual data associated with the media source, the media timeline contextual data including data correlated to a time period corresponding to the time period including T₀ to Tₙ;
processing the media timeline contextual data based on one or more segmentation algorithms, thereby to define a plurality of clip segments, wherein each clip segment includes:
(i) clip segment contextual data derived from the media timeline contextual data; and
(ii) data representative of a clip segment time period defined relative to the timeline, wherein for a given clip segment the clip segment time period is from Tᵢ to Tⱼ, wherein 0≤i≤j≤n;
storing data representative of the defined clip segments in a clip content library.

2. A method according to claim 1 including configuring the clip content library to make the data representative of the defined clip segments available for access via a messaging interface, such that the messaging interface is enabled to:
(i) perform a search thereby to identify a search result set including one or more clip segments, wherein the search is based upon a search query that is processed against clip segment contextual data;
(ii) enable the user to review the result set and then select a desired clip segment from the search result set; and
(iii) cause rendering at a recipient device of a set of frames from the media source associated with the clip segment time period.

3. A method according to claim 2 wherein causing rendering at a recipient device of a set of frames from the media source associated with the clip segment time period includes: delivering to the recipient device frame data for the set of frames.

4. A method according to claim 3 wherein the frame data is available in the clip content library.

5. A method according to claim 3 wherein the frame data is available from a master media source.

6. A method according to claim 2 wherein causing rendering at a recipient device of a set of frames from the media source associated with the clip segment time period includes: delivering to the recipient device data that causes retrieval of frame data for the set of frames.

7. A method according to claim 6 wherein the frame data is retrieved from the clip content library.

8. A method according to claim 6 wherein the frame data is retrieved from a data source other than the clip content library.

9. A method according to claim 6 wherein the frame data for the set of frames is stored as an isolated frame data set.

10. A method according to claim 6 wherein the frame data for the set of frames is retrieved via on-demand extraction from a larger media file using the data representative of the clip segment time period.

11. A method according to claim 1 wherein the media timeline contextual data associated with the media source includes subtitle data.

12. A method according to claim 11 including applying a processing algorithm thereby to extract searchable text data from the subtitle data.

13. A method according to claim 12 wherein the processing algorithm includes a character recognition algorithm.

14. A method according to claim 1 wherein the media timeline contextual data associated with the media source includes a contextual log.

15. A method according to claim 14 wherein the contextual log is manually defined.

16. A method according to claim 1 wherein the one or more segmentation algorithms include one or more segmentation algorithms configured to identify sentence and/or conversation delimiters.

17. A method according to claim 1 wherein the one or more segmentation algorithms include one or more segmentation algorithms configured to identify logically separable segments of less than a threshold time period.

18. A method according to claim 1 wherein the one or more segmentation algorithms additionally process the media frame data, thereby to identify media-based clip delimiters.

19. A device that is configured to execute a messaging interface that delivers a result set of clip segments in response to a search query, wherein clip segments are identified in a clip content library generated according to the method of claim 1.

20. A computer system configured to perform a method according to claim 1.

21. A non-transitory carrier medium carrying computer executable code that, when executed on a processor, causes the processor to perform a method according claim 1.

22-78. (canceled)
